(19) United States
(12) Patent Application Publication
(10) Pub. No.: US 2016/0230790 A1
(43) Pub. Date: Aug. 11, 2016

(54) RETRACTABLE LOCKING MECHANISM FOR A VEHICLE ACCESSORY MOUNTING SYSTEM

(71) Applicant: JARROD R. NOLAN, WICHITA, KS (US)

(72) Inventor: JARROD R. NOLAN, WICHITA, KS (US)

(21) Appl. No.: 15/017,044

(22) Filed: Feb. 5, 2016

Related U.S. Application Data
(60) Provisional application No. 62/112,544, filed on Feb. 5, 2015.

(51) Int. Cl. F16B 1/04

(52) U.S. Cl. CPC F16B 1/04

(57) ABSTRACT

A retractable locking mechanism for securing an accessory to a surface, the retractable locking mechanism including a gear carriage, a gear assembly, an input mechanism, and a retractor lever. The gear carriage shifts between a deployed position and a non-deployed position and includes a gear assembly cavity. The gear assembly is positioned in the gear assembly cavity and includes one or more gears and an extendable locking member in driven engagement with the gears. The input mechanism rotates the gears for extending the extendable locking member into a locked position and retract the extendable locking member to an unlocked position when the gear carriage is in the deployed position.

### RELATED APPLICATIONS

This non-provisional patent application claims priority benefit with regard to all common subject matter of earlier-filed U.S. Provisional Patent Application Ser. No. 62/112,544, filed on Feb. 5, 2015, and entitled “RETRACTABLE LOCKING MECHANISM FOR A VEHICLE ACCESSORY MOUNTING SYSTEM.” The identified earlier-filed provisional patent application is hereby incorporated by reference in its entirety into the present application.

### BACKGROUND

Locking mechanisms are often used to mount toolboxes, cargo, and other accessories to vehicles, floors, shelves, and other surfaces. Many conventional locking mechanisms extend from the accessories and often break or inadvertently catch on other objects. Conventional locking mechanisms also often make it difficult to open the accessories. Furthermore, locking features on conventional locking mechanisms often do not fully lock or can unintentionally become unlocked when other equipment or cargo inadvertently contact them.

### SUMMARY

Embodiments of the present invention solve the above-mentioned problems and provide a distinct advance in the art of locking mechanisms. More particularly, the present invention provides retractable locking mechanisms for securing accessories to a surface such that the retractable locking mechanisms are retained in the accessories when not in use and cannot unintentionally become unlocked when in a locked position.

One embodiment of the retractable locking mechanism comprises a gear carriage, a gear assembly, an input mechanism, and a retractor lever. The gear carriage shifts between a deployed position and a non-deployed position and includes a gear assembly cavity. The gear assembly is positioned in the gear assembly cavity and includes one or more gears and an extendable locking member in driven engagement with the gears. The input mechanism rotates the gears for extending the extendable locking member into a locked position and retract the extendable locking member to an unlocked position when the gear carriage is in the deployed position.

Another embodiment of the present invention is a system of retractable locking mechanisms for securing an accessory to a surface. Each retractable locking mechanism includes a gear carriage, a gear assembly, an input mechanism, and a retractor lever. The gear carriage shifts between a deployed position and a non-deployed position and includes a gear assembly cavity. The gear assembly is positioned in the gear assembly cavity and includes one or more gears and an extendable locking member in driven engagement with the gears. The input mechanism rotates the gears for extending the extendable locking member into a locked position and retract the extendable locking member to an unlocked position when the gear carriage is in the deployed position. The retractable locking mechanisms may be aligned with and spaced apart from each other a pre-determined distance so that the retractable locking mechanisms may be received in spaced apart locking anchors of a vehicle accessory mounting assembly.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawings figures.

### BRIEF DESCRIPTION OF THE DRAWING FIGURES

Embodiments of the present invention are described in detail below with reference to the attached drawing figures, wherein:

FIG. 1 is an assembly view of an accessory mounting assembly constructed in accordance with an embodiment of the present invention;

FIG. 2 is a perspective view of a lock anchor of the accessory mounting assembly of FIG. 1;

FIG. 3 is a perspective view of an input mechanism of a retractable locking mechanism constructed in accordance with an embodiment of the present invention;

FIG. 4 is; a perspective view of a retractable locking mechanism constructed in accordance with an embodiment of the present invention;

FIG. 5 is a partial cutaway view of the retractable locking mechanism of FIG. 4; and

FIG. 6 is a perspective view of a number of accessories stacked vertically in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to one embodiment“, an embodiment”, or “embodiments” mean that the feature or features being referred to are included in at least one embodiment of the technology. Separate references to one embodiment“, an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

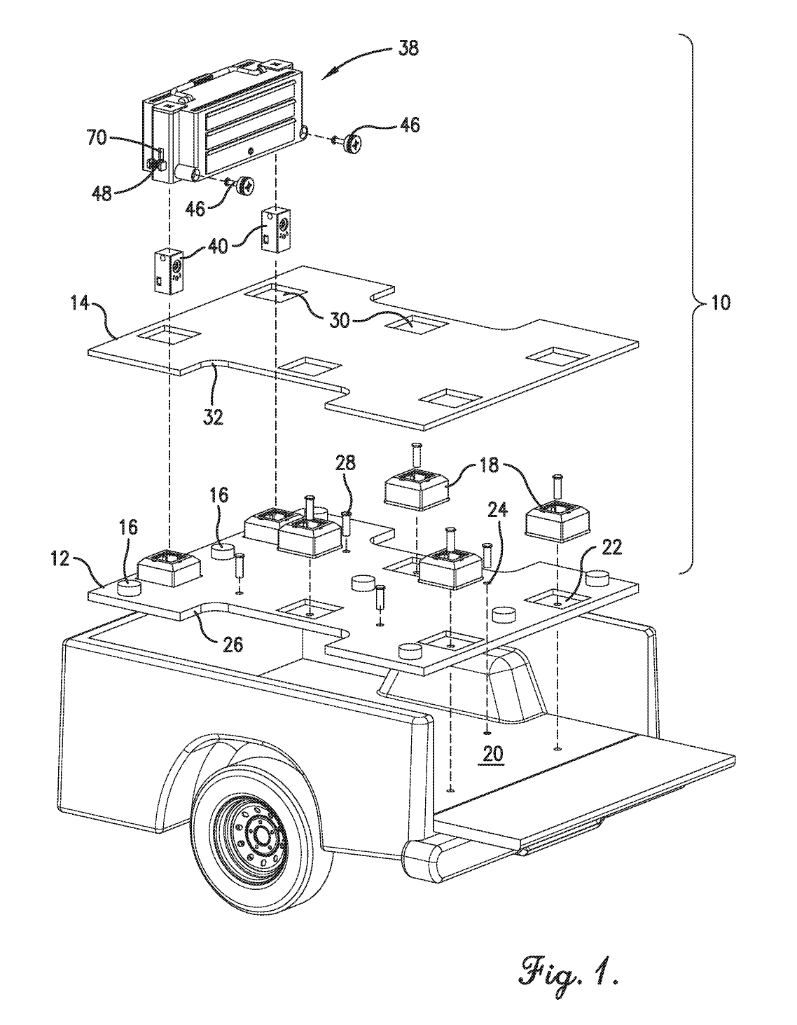

The retractable locking mechanism of the present invention may be used with a vehicle accessory mounting assembly illustrated in FIG. 1. The vehicle accessory mounting assembly 10 broadly comprises a base layer 12, an upper floor layer 14, a plurality of support members 16, and a plurality of lock anchors 18.

The base layer 12 supports the accessory mounting assembly in a vehicle bed 20 or other surface such as the bed of a truck or a storage shelf and may be formed of molded plastic, wood, metal, or any other suitable material. The base layer 12 includes a plurality of lock anchor recesses 22, a plurality of vehicle bed fastener openings 24, and left and right wheel well contours 26. The base layer 12 may be sized to fit within any sized vehicle bed. Embodiments of the base layer 12 may also be configured for mounting in other places such as in a vehicle trunk.

The lock anchor recesses 22 receive the lock anchors 18 therein and may be square, rectangular, circular, or any other suitable shape. The lock anchor recesses 22 may be cavities or openings and may be arranged in a uniformly distributed pattern in lateral and longitudinal directions. In one embodiment, the lock anchor recesses 22 may be arranged in an orthogonal pattern with five rows with twenty-four lock anchor recesses total such that the first, fifth, and sixth rows have five lock anchor recesses each and the second, third, and fourth rows have three lock anchor recesses each.

The vehicle bed fastener openings 24 receive vehicle bed fasteners 28 therethrough and may be threaded and/or circular openings. In one embodiment, the vehicle bed fastener openings 24 may include eight openings with four openings positioned near left and right sides of the base layer 12 for securing the base layer 12 to the vehicle bed 20 by tightening the vehicle bed fasteners 28 through the vehicle bed fastener openings 24 into corresponding fastener openings in the vehicle bed 20. The vehicle bed fastener openings 24 may be positioned so that an in-bed utility hitch may be used between the wheel wells in conjunction with the vehicle accessory mounting assembly 10.

The left and right wheel contours 26 may be large cut-out shapes extending inwardly from left and right sides of the base layer 12 for accommodating raised wheel well areas of the vehicle bed 20.

The upper floor layer 14 supports accessories and cargo thereon and may be formed of molded plastic, wood, metal, or any other suitable material. The upper floor layer 14 may include a plurality of lock anchor upper openings 30 and left and right wheel well contours 32. In one embodiment, the upper floor layer 14 may be sealed to the truck bed or other surface.

The lock anchor upper openings 30 receive the lock anchors 18 therethrough and may be square, rectangular, circular, or any other suitable shape. In one embodiment, the lock anchor upper openings 30 may be arranged in a uniformly distributed pattern in lateral and longitudinal directions. The lock anchor upper openings 30 may be arranged to correspond with the locations of the lock anchor recesses 22.

The left and right wheel well contours 32 may be similar to and positioned above the left and right wheel contours 26 of the base layer 12 for accommodating the raised wheel well areas of the vehicle bed 20.

The plurality of support members 16 distribute the weight of the accessories and cargo and absorb shocks and vibrations transmitted from the vehicle for protecting the accessories and cargo. The support members 16 are positioned between the base layer 12 and the upper floor layer 14 and spaced apart from each other. The support members 16 may be formed of shock absorbing material and/or may be shaped to dissipate the shock forces. In one embodiment, the support members 16 are clipped to the upper floor layer 14 for securing the upper floor layer 14 to the support members 16.

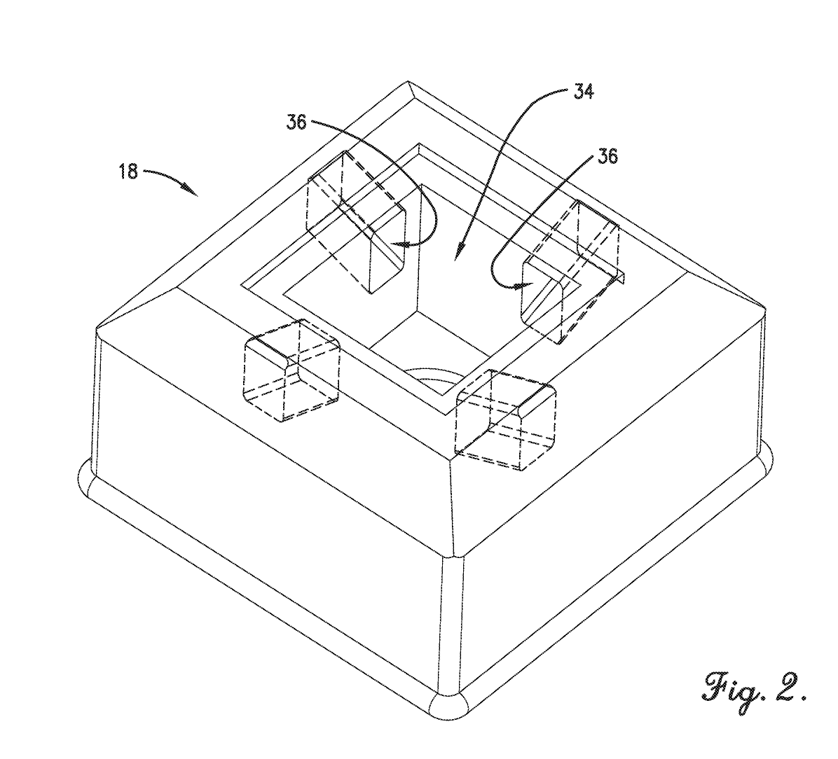

The plurality of lock anchors 18 secure retractable locking mechanisms (described below) of the accessories thereto and are positioned in the lock anchor recesses 22. The lock anchors 18 each may include an open-topped central cavity 34 and one or more side openings 36, as shown in FIG. 2. In other embodiments, the lock anchors 18 may be shaped and/or integrated into the base layer 12 and/or the upper floor layer 14 for receiving locking mechanisms of the accessories shaped differently than the retractable locking mechanisms described below.

The open-topped central cavity 34 receives the retractable locking mechanisms therein and may be square, rectangular, circular, or other suitable shape. The open-topped central cavity 34 may have drainage holes and/or mounting holes at the bottom thereof.

The one or more side openings 36 each receive an extendable locking member (described below) therein for securing the retractable locking mechanism in the open-topped central cavity 34. The one or more side openings 36 may be channels, recesses, slots, catches, or similar features and may extend diagonally upwards and outwards from any of the sides (such as opposite sides or all sides) of the open-topped central cavity 34. The one or more side openings 36 may be angled at 26 degrees (1 degree less than the extendable locking members described below) to encourage friction therebetween as the extendable locking members are engaged.

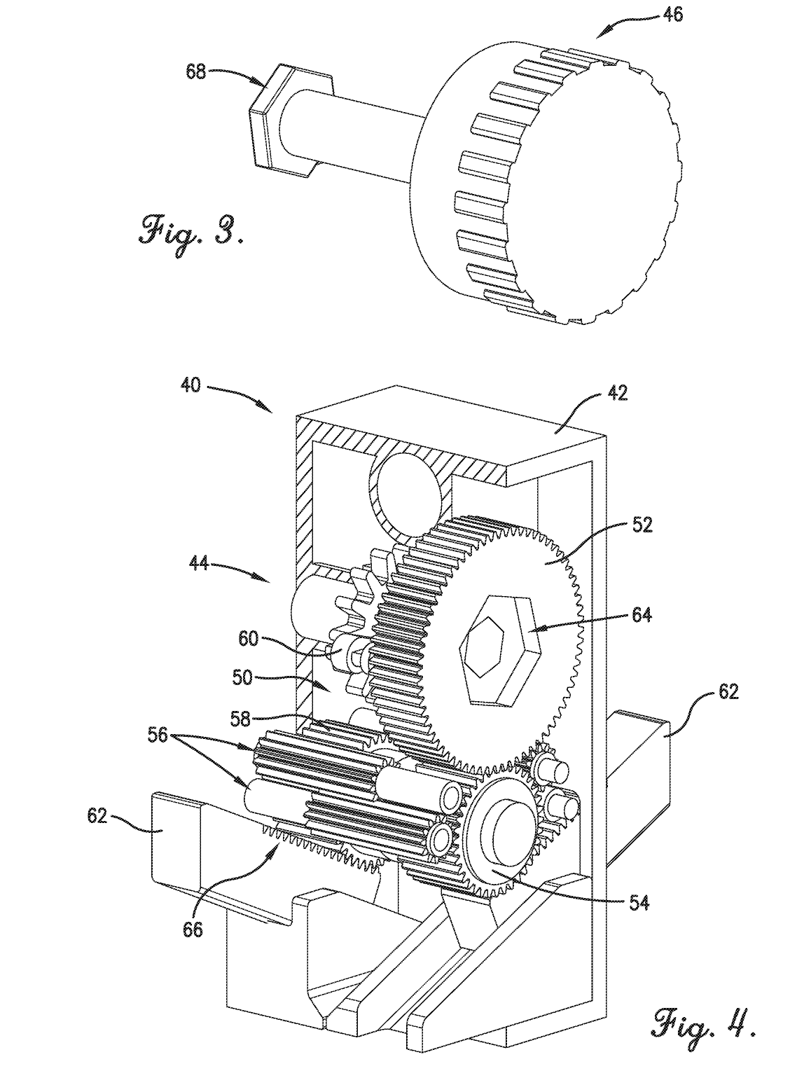

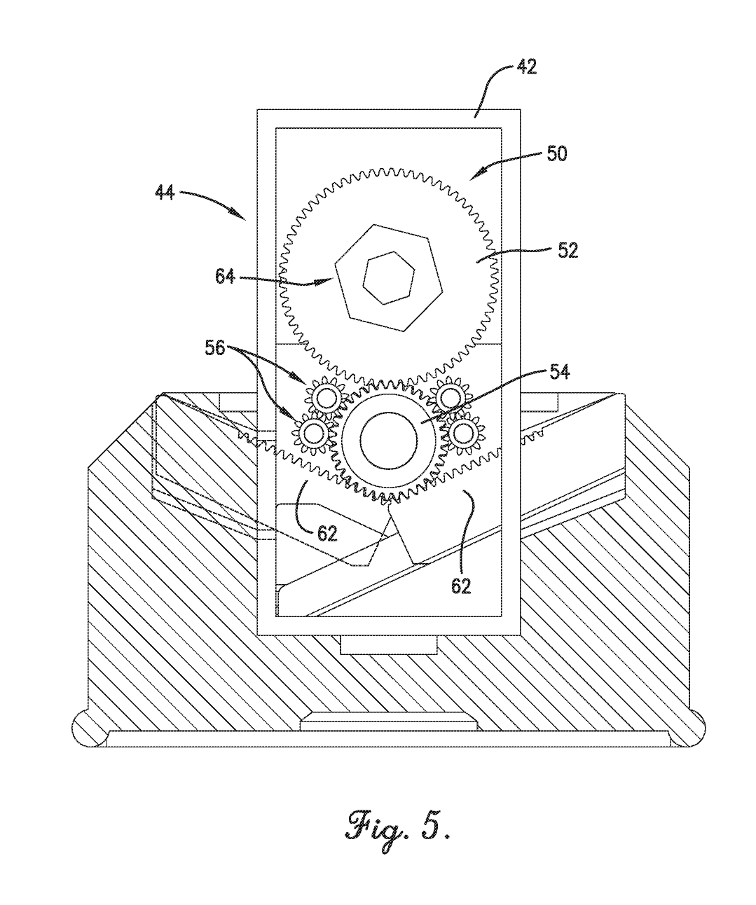

Turning to FIGS. 3-6, accessories 38 such as toolboxes, containers, chests, cargo, and other objects can be secured to the accessory mounting assembly 10 via retractable locking mechanisms 40. Each retractable locking mechanism 40 broadly comprises a gear carriage 42, a gear assembly 44, an input mechanism 46, and a retractor lever 48, as shown in FIGS. 1 and 3-5.

The gear carriage 42 supports the gear assembly 44 and may be substantially square, rectangular, or other similar shape. The gear carriage 42 may include a cavity 50 for receiving the gear assembly 44 therein and one or more side openings for receiving gear shafts and the extendable locking members (described below) therethrough.

The gear assembly 44 converts a force received from the input mechanism 46 into a locking motion and includes a driver gear 52, a primary gear 54, a number of transfer gears 56, a secondary gear 58, one or more extendable locking members 62. It will be understood that other force transfer and force conversion configurations, assemblies, and components such as pulleys, linkages, cams, bearings, and levers may be used.

The driver gear 52 receives rotational force from the input mechanism 46 and transfers the force to the primary gear 54. The driver gear may include an engagement recess 64 or protrusion having a hexagonal, star, square, or similar shape for rotationally and engaging (and being disengaged from) the input mechanism 46. The driver gear 52 may be spring loaded along its rotational axis and may be configured to engage a catch 60 when the spring force is unloaded such that the gear assembly 44 is unable to turn unless the driver gear 52 is urged against the spring force via the input mechanism 46.

The primary gear 54 transfers rotational force from the driver gear 52 to one of the extendable locking members 62 and to the transfer gears 56. The transfer gears 56 transfer rotational force from the primary gear 54 to the secondary gear 58. The secondary gear 58 transfers rotational force to one or more other extendable locking members 62.

The extendable locking members 62 shift between retracted unlocked positions and extended locked positions when the input mechanism 46 is turned by converting rotational force from the primary gear 54 and the secondary gear 58 into translational movement. The extendable locking members 62 may be 1.5 inches long and 1 inch wide. The extendable locking members 62 may include teeth 66 that are engaged by the gear teeth of the primary driver gear 52 and the secondary gear 58. The extendable locking members 62 may be angled upwards at approximately 27 degrees for improved leverage.

The input mechanism 46 allows a user to lock the retractable locking mechanisms 40 to, and unlock the retractable locking mechanisms 40 from, the accessory mounting assembly 10. The input mechanism 46 may include a shaft with a hexagonal, star, square, or similarly shaped shaft end 68 for rotationally engaging the driver gear 52. The input mechanism 46 may be a knob, lever, dial, or other similar mechanism.

The retractor lever 48 shifts the retractable locking mechanism 40 between deployed and un-deployed positions and may extend through a vertical slot 70 in the accessory 38, as shown in FIG. 1. The retractor lever 48 may be spring loaded and may be lockable in the deployed and/or un-deployed positions.

Use of the vehicle accessory mounting assembly 10 will now be described in more detail. First, the vehicle accessory mounting assembly 10 may be mounted in a truck bed, trunk, trailer, or similar cargo area, storage space, shelf, or other surface by tightening the vehicle bed fasteners 28 through the vehicle bed fastener openings 24 of the base layer 12 to the cargo area. An accessory 38 such as a toolbox or toolkit may be placed on the upper layer 14 of the vehicle accessory mounting assembly 10. The retractable locking mechanisms 40 of an accessory 38 may be aligned with one or more of the lock anchors 18 so as to organize one or more accessories on the vehicle accessory mounting assembly 10 as desired. The accessory 38 may be oriented laterally or longitudinally so long as the retractable locking mechanisms 40 are aligned with the lock anchors 18. The retractor levers 48 of the accessory 38 may then be pushed downward so as to shift the retractable locking mechanisms 40 into a deployed position within the open-topped cavities 34 of the lock anchors 18.

Each retractable locking mechanism 40 may be locked to the vehicle accessory mounting assembly 10 as follows. The input mechanism 46 may then be pushed axially inward so that the input mechanism 46 engages the driver gear 52 and frees the driver gear 52 from the catch 60. The input mechanism 46 may then be rotated so as to transfer a rotational force through the gear assembly 44 to the extendable locking members 62 and urge the extendable locking members 62 outward into the side openings 36 of the lock anchors 18 in a locking position. The input mechanism 46 may then be pulled axially outward to disengage the input mechanism 46 from the gear assembly 44 such that the driver gear engages the catch 60 and prevents the retractable locking mechanism 40 from being unlocked. The accessory 38 will thus be locked in place on the vehicle accessory mounting assembly 10.

The retractable locking mechanism 40 may then be unlocked from the vehicle accessory mounting assembly 10 as follows. The input mechanism 46 may be pushed axially inward so that the input mechanism 46 again engages the driver gear 52 and frees the driver gear 52 from the catch 60. The input mechanism 46 may then be rotated so as to transfer a rotational force to the extendable locking members 62 and retract the extendable locking members 62 from the side openings 36 of the lock anchors 18. The retractor lever 48 may then be pulled upwards to urge the retractable locking mechanism 40 from the open-topped central cavity 34 of the lock anchor 18. The input mechanism 46 may then be pulled axially outward to disengage the input mechanism 46 from the gear assembly 44 and re-engage the driver gear 52 with the catch 60 to prevent the retractable locking mechanism 40 from unintentionally shifting to a locked position. The accessory 38 may then be picked up and/or rearranged as desired.

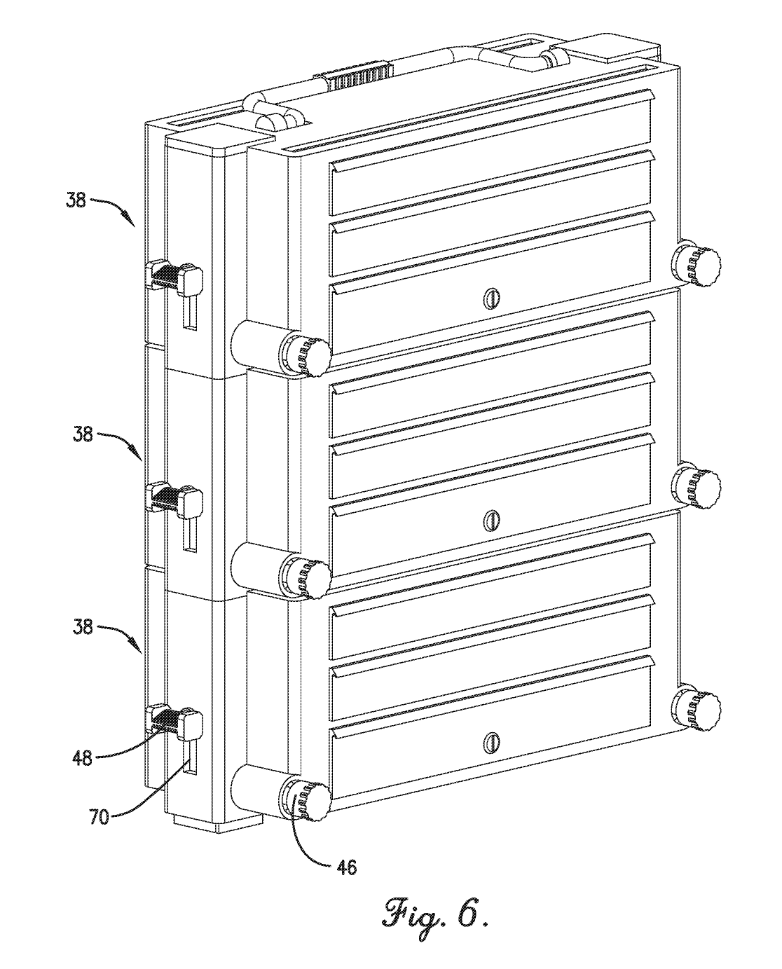

It will be understood that the vehicle accessory mounting assembly 10 may be used in truck and other vehicle beds, in vehicle trunks, on top of truck bed walls, in or on trailers, vehicle roofs and vehicle roof racks, all-terrain vehicles (ATVs), aircraft, stud walls, garages, and any other location for temporarily or permanently storing, transporting, securing, and arranging accessories and vehicle components. For example, the vehicle accessory mounting assembly may be formed into “one segment” strips having a single row of lock anchors. The strips may be mounted to wall studs for attaching wall accessories and features such as cabinets, benches, shelves thereto. The strips may also be mounted to the floor of an aircraft for anchoring aircraft seats thereto. In other embodiments, the strips may be mounted in or on a trailer, an SUV, a car, or other implement. In some embodiments, as shown in FIG. 6, the accessories 38 may be stacked on top of each other for further organized transport or storage.

The present invention provides many advantages over prior art accessory locking mechanisms. For example, the vehicle accessory mounting assembly 10 allows the user to positively lock accessories in place without additional clamps, hooks, cables, or netting. The vehicle accessory mounting assembly 10 allows the user freedom to rearrange accessories as desired and allows any accessories with retractable locking mechanisms 40 to be attached to the vehicle accessory mounting assembly 10. The vehicle accessory mounting assembly 10 also absorbs shocks and vibrations between the vehicle and the accessories to prevent the accessories from becoming damaged. The retractable locking mechanisms 40 retract completely into the accessories to protect the retractable locking mechanisms 40 and to prevent them from catching on other objects when not in use. The vehicle accessory mounting assembly 10 also protects the vehicle bed from exposure to the elements and damage from the accessories.

Although the invention has been described with reference to the embodiments illustrated in the attached drawing figures, it is noted that equivalents may be employed and substitutions made herein without departing from the scope of the invention.

1. A retractable locking mechanism for securing an accessory to a surface, the retractable locking mechanism comprising:
a gear carriage configured to be shifted downward to a deployed position and shifted upwards to a non-deployed position, the gear carriage including a gear assembly cavity;
a gear assembly positioned in the gear assembly cavity of the gear carriage, the gear assembly including at least one gear and at least one extendable locking member in driven engagement with the at least one gear; and
an input mechanism configured to rotate the at least one gear so as to extend the at least one extendable locking member from the gear assembly cavity into at least one shaft opening of a lock anchor in a locked position and retract the at least one extendable locking member from the at least one shaft opening of the lock anchor into the gear assembly cavity in an unlocked position when the gear carriage is in the deployed position.

2. The retractable locking mechanism of claim 1, further comprising a retractor lever for shifting the retractable locking mechanism from the non-deployed position to the deployed position.

3. The retractable locking mechanism of claim 1, wherein the input mechanism is a knob is retractable between an engaging position and a non-engaging position, the knob being configured to rotate the at least one gear when the knob is in the engaging position, the knob being unable to rotate the at least one gear when the knob is in the non-engaging position.

4. The retractable locking mechanism of claim 1, wherein the at least one extendable locking member includes a first extendable locking member and a second extendable locking member.

5. The retractable locking mechanism of claim 4, wherein the at least one gear is a driver gear and the gear assembly further comprises a primary gear, at least one transfer gear, and a secondary gear, the primary gear being driven by the driver gear and being configured to drive the first extendable locking member, the secondary gear being driven by the primary driver gear via the at least one transfer gear and being configured to drive the second extendable locking member.

6. The retractable locking mechanism of claim 5, wherein the first and second extendable locking members include top sides having gear teeth configured to be driven by the primary gear and the secondary gear.

7. The retractable locking mechanism of claim 4, wherein the first extendable locking member and second extendable locking member are offset from each other.

8. The retractable locking mechanism of claim 1, wherein the at least one extendable locking member is between 1 inch and 1.5 inches wide.

9. The retractable locking mechanism of claim 1, wherein the at least one extendable locking member extends upwards and outwards from the cavity when the at least one extendable locking member is in the locked position.

10. The retractable locking mechanism of claim 1, wherein the at least one extendable locking member extends at a different angle in relation to the at least one shaft opening so that the at least one extendable locking member is resistively retained in the at least one shaft opening when the at least one extendable locking member is extended into the at least one shaft opening.

11. The retractable locking mechanism of claim 10, wherein the at least one extendable locking member extends at a one degree angle in relation to the at least one extendable locking member.

12. The retractable locking mechanism of claim 1, wherein the at least one extendable locking member is configured to be reversibly retained in the extended position.

13. The retractable locking mechanism of claim 1, wherein the retractable locking mechanism is configured to be secured to the surface in one of four orthogonal orientations.

14. A system of retractable locking mechanisms for securing an accessory to a surface, each retractable locking mechanism comprising:
a gear carriage configured to be shifted downward to a deployed position and shifted upwards to a non-deployed position, the gear carriage including a gear assembly cavity;
a gear assembly positioned in the gear assembly cavity of the gear carriage, the gear assembly including at least one gear and at least one extendable locking member in a driven relation with least one gear; and
an input mechanism configured to rotate the at least one gear so as to extend the at least one extendable locking member from the gear assembly cavity into at least one shaft opening of a lock anchor in a locked position and retract the at least one extendable locking member from the at least one shaft opening of the lock anchor into the gear assembly cavity in an unlocked position when the gear carriage is in the deployed position.

15. The system of retractable locking mechanisms of claim 14, wherein the retractable locking mechanisms are aligned with each other.

16. The system of retractable locking mechanisms of claim 14, wherein the retractable locking mechanisms are positioned on opposite sides of the accessory.

17. The system of retractable locking mechanisms of claim 14, wherein the retractable locking mechanisms are spaced a predetermined distance apart from each other for being received in pre-set lock anchors.

18. The system of retractable locking mechanisms of claim 14, wherein the system of retractable locking mechanisms is attached to sides of a toolbox and configured to secure the toolbox to the surface.

19. The system of retractable locking mechanisms of claim 14, wherein the system of retractable locking mechanisms is configured to secure the accessory to a truck bed.

20. A system of retractable locking mechanisms for securing an accessory to a surface, each retractable locking mechanism comprising:
a gear carriage configured to be shifted downward to a deployed position and shifted upwards to a non-deployed position, the gear carriage including a gear assembly cavity;
a gear assembly positioned in the gear assembly cavity of the gear carriage, the gear assembly including a primary gear, at least one transfer gear, a secondary gear, a first extendable locking member in driven engagement with the primary gear, and a second extendable locking member in driven engagement with the secondary gear, the first extendable locking member and the second extendable locking member extending upwards and outwards from the gear assembly cavity when in the locked position;
a knob shiftable between an engaging position and a non-engaging position, the knob configured to rotate the primary gear when the knob is in the engaging position so as to extend the first extendable locking member and the second extendable locking member from the gear assembly cavity into shaft openings of a lock anchor in a locked position and retract the first extendable locking member and the second extendable locking member from the at shaft openings of the lock anchor into the gear assembly cavity in an unlocked position when the gear carriage is in the deployed position, the knob being unable to rotate the at least one gear when the knob is in the non-engaging position; and
a retractor lever for shifting the retractable locking mechanism from the non-deployed position to the deployed position.
